(19) United States
(12) Patent Application Publication
(10) Pub. No.: US 2024/0306713 A1
(43) Pub. Date: Sep. 19, 2024

(54) AEROSOL GENERATION DEVICE

(71) Applicant: NICOVENTURES TRADING LIMITED, London (GB)

(72) Inventors: Sioned OWEN, Brighton Sussex (GB); Kaveh GHANOUNI, London Greater London (GB)

(21) Appl. No.: 18/264,137

(22) PCT Filed: Jan. 13, 2022
(86) PCT No.: PCT/EP2022/050681

§ 371 Date: Aug. 3, 2023

(30) Foreign Application Priority Data
Feb. 3, 2021 (GB) 2101458.4

(51) Int. Cl. A24F 40/46; A24F 40/20; A24F 40/465; H05B 3/34; H05B 6/10

(52) U.S. Cl. CPC A24F 40/46; A24F 40/20; A24F 40/465; H05B 3/34; H05B 6/108

(57) ABSTRACT

An aerosol generation device for generating an aerosol from an aerosol forming consumable. The aerosol generation device includes a heater element and a system for causing heating of the heater element. The heater element defines, at least partially, a heater chamber for receiving the aerosol forming consumable therein. The heater element is constrictable, in use, to reduce the volume of the heater chamber from a first volume to a second volume.

### CROSS-REFERENCE TO RELATED APPLICATIONS

The present application is a National Phase Entry of PCT Application No. PCT/EP2022/050681, filed Jan. 13, 2022, which claims priority from GB Application No. 2101458.4, filed Feb. 3, 2021, each of which is hereby fully incorporated by reference in their entirety.

### TECHNICAL FIELD

The present invention relates to an aerosol generation device and a heater element for an aerosol generation device.

### BACKGROUND

Smoking articles such as cigarettes, cigars and the like burn tobacco during use to create tobacco smoke. Attempts have been made to provide alternatives to these articles that burn tobacco by creating products that release compounds without burning.

Examples of such articles are heating devices which release compounds by heating, but not burning, the material. The material may be, for example, tobacco or other non-tobacco products, which may or may not contain nicotine. Heating tobacco or non-tobacco products may volatilize e at least one component of the tobacco or non-tobacco products, typically to form an aerosol which can be inhaled, without burning or combusting the tobacco or non-tobacco products.

A heating device that heats the tobacco or non-tobacco product may be described as a ‘heat-not-burn’ apparatus or a ‘tobacco heating product’ (THP) or ‘tobacco heating device’ or similar. Various arrangements have been tried for volatilising at least one component of tobacco or non-tobacco products.

### SUMMARY

A first aspect of the invention provides an aerosol generation device for generating an aerosol from an aerosol forming consumable. The aerosol generation device comprises: at least one heater element, the heater element defining, at least partially, a heater chamber for receiving the aerosol forming consumable therein; a system for causing heating of the heater element; and wherein the heater element is constrictable, in use, to reduce a volume of the heater chamber from a first volume to a second volume. The aerosol generation device may have any of the example features as described herein.

In certain examples, the heater element encircles the aerosol forming consumable when the aerosol forming consumable is inserted into the heating chamber.

In certain examples, the heater element comprises a first portion and a second portion.

In certain examples, the heater element comprises an elongate hollow tube. In certain examples, the heater element is configured to constrict to reduce an internal dimension of the elongate hollow tube.

In certain examples, the elongate hollow tube is defined by a tubular wall and the elongate hollow tube comprises a split in the tubular wall of the elongate hollow tube. In certain examples, the split extends longitudinally along the elongate hollow tube.

In certain examples, the elongate hollow tube has a C-shaped cross section.

In certain examples, the elongate hollow tube has a substantially circular cross section.

In certain examples, the elongate hollow tube has wall tubular wall ends defined by the split and the tubular wall ends move in a circumferential direction of the elongate hollow tube when the heater element constricts in use. In certain examples, the tubular wall ends overlap in the circumferential direction of the elongate hollow tube.

In certain examples, the heater element is configured to constrict to reduce a diameter of the elongate hollow tube.

A second aspect of the invention provides an aerosol generation device for generating an aerosol from an aerosol forming consumable. The aerosol generation device comprises: at least one heater element, the heater element defining, at least partially, a heater chamber for receiving the aerosol forming consumable therein; a system for causing heating of the heater element; and wherein the heater element comprises a first portion and a second portion integrally formed with the first portion and wherein the first portion of the heater element is, in use, moveable relative to the second portion of the heater element to reduce a volume of the heater chamber from a first volume to a second volume. The aerosol generation device may have any of the example features as described herein.

In certain examples, the first portion and the second portion form a sleeve, and the sleeve envelops the aerosol forming consumable when it is received in the heating chamber.

In certain examples, the heating chamber is a triangular prism shaped space defined, at least partially, by the first portion and the second portion.

In certain examples, the heater element comprises a bimetallic strip.

In certain examples, the heater element comprises a piezoelectric actuator.

In certain examples, the heater element comprises a bellows.

In certain examples, the heater element comprises a homogeneous, or substantially homogeneous, material.

In certain examples, the heater element comprises one or more materials selected from the group consisting of: an electrically-conductive material, a magnetic material, and a magnetic electrically-conductive material.

In certain examples, the heater element comprises a metal or a metal alloy.

In certain examples, the heater element comprises one or more materials selected from the group consisting of: aluminium, gold, iron, nickel, cobalt, conductive carbon, graphite, plain-carbon steel, stainless steel, ferritic stainless steel, steel, molybdenum, silicon carbide, copper, and bronze.

In certain examples, the at least one heater element comprises a plurality of heater elements and wherein each of the heater elements may be moved, in use, towards or away from the aerosol forming consumable independently of each other.

In certain examples, the system for causing heating of the heater element is an inductive heating system. In certain examples, the system for causing heating of the heater element is a resistive heating system.

A third aspect of the invention provides an aerosol generation system comprising an aerosol generation device according to the first aspect or the second aspect and at least one aerosol forming consumable, wherein the at least one aerosol forming consumable is shaped and sized to be receivable within the heating chamber. The aerosol generation device may have any of the example features as described herein. The aerosol forming consumable may have any of the of the example features as described herein.

A fourth aspect of the invention provides method of heating an aerosol forming consumable. The method comprises: receiving an aerosol forming consumable in a heating chamber of an aerosol generation device, the heating chamber at least partially defined by a heater element that is constrictable; constricting the heater element to reduce a volume of the heater chamber from a first volume to a second volume.

A fifth aspect of the invention provides method of heating an aerosol forming consumable. The method comprises: receiving an aerosol forming consumable in a heating chamber of an aerosol generation device, the heating chamber at least partially defined by a heater element that is constrictable; moving a first portion of the heater element relative to a second portion of the heater element, the second portion integrally formed with the first portion, to reduce a volume of the heating chamber from a first volume to a second volume.

Further features and advantages will become apparent from the following detailed description of certain examples, which are described with reference to the accompanying drawings.

### BRIEF DESCRIPTION OF THE DRAWINGS

Certain examples will now be described with reference to accompanying drawings, in which:

FIG. 1 schematically illustrates an example of an aerosol generation device;

FIG. 2 schematically illustrates an example of an aerosol generation device;

FIG. 3 shows an example of a heater element from an example aerosol generation device;

FIG. 4 shows an example of a heater element from an example aerosol generation device;

FIG. 5 shows an example of a heater element from an example aerosol generation device;

FIG. 6 schematically illustrates a cross section through an example of a heater element from an example aerosol generation device;

FIG. 7 schematically illustrates an example of a heating chamber defined, in part, by an example of a heater element from an example aerosol generation device;

FIG. 8 schematically illustrates a cross section through an example of a heater element; and

FIG. 9 schematically illustrates an example of an aerosol generation device.

### DETAILED DESCRIPTION

Tobacco and/or non-tobacco products, of which at least one component is to be volatilized, may be described as aerosol-generating material(s). Aerosol-generating material is a material that is capable of generating aerosol, for example when heated, irradiated or energized in any other way. An ‘aerosol-generating material’ is any suitable material from which an aerosol may be generated. In certain examples, an aerosol generated from an aerosol-generating material may be generated by applying heat to the aerosol-generating material.

Aerosol-generating material may, for example, be in the form of a solid, liquid or gel which may or may not contain an active substance and/or flavorants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavors, one or more aerosol-former materials, and optionally one or more other functional material.

In certain examples, the aerosol-generating material may be a solid. In certain examples, the aerosol-generating material may comprise a foam. In certain examples, the aerosol-generating material may comprise a thin-film.

In certain examples, the aerosol-generating material may be a tobacco material. In certain examples, the aerosol-generating material may contain a nicotine source and no tobacco material. In certain examples, the aerosol-generating material may contain a tobacco material and a separate nicotine source. In certain examples, the aerosol-generating material may not contain a nicotine source. In certain examples, the aerosol-generating material may contain a flavor.

In examples where the aerosol-generating material comprises a gel, the gel may comprise a nicotine source. In some examples, the gel may comprise a tobacco material. In some cases, the gel may comprise a tobacco material and a separate nicotine source. For example, the gel may additionally comprise powdered tobacco and/or nicotine and/or a tobacco extract.

In certain examples where the aerosol-generating material comprises a gel, the gel may comprise a gelling agent. The gelling agent may comprise a hydrocolloid. In certain examples where the aerosol-generating material comprises a gel, the gel may comprise a hydrogel. The gel may additionally comprise a solvent.

In certain examples, where an aerosol is generated from heating an aerosol-generating material, the aerosol-generating material may be heated to temperatures between around 50° C. to around 250° C. or 300° C.

It may be noted that, in general, a vapor is a substance in the gas phase at a temperature lower than its critical temperature, which means that, for example, the vapor can be condensed to a liquid by increasing its pressure without reducing the temperature. On the other hand, in general, an aerosol is a colloid of fine solid particles or liquid droplets, in air or another gas. A colloid is a substance in which microscopically dispersed insoluble particles are suspended throughout another substance.

For reasons of convenience, as used herein, the term ‘aerosol’ should be taken as meaning an aerosol, a vapor or a combination of an aerosol and vapor.

As used herein, the term ‘aerosol-generating material’ may, in certain examples, include an ‘aerosol-former material’, which refers to an agent that promotes the generation of an aerosol. For example, where the aerosol-generating material comprises a gel, the gel may comprise an aerosol-former material. An aerosol-former material may promote the generation of an aerosol by promoting an initial vaporisation and/or the condensation of a gas to an inhalable solid and/or liquid aerosol.

The aerosol-former material may comprise one or more constituents capable of forming an aerosol. Suitable aerosol-former materials include, but are not limited to, one or more of: glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate. The aerosol-former material may suitably have a composition that does not dissolve menthol. The aerosol-former material may suitably comprise, consist essentially of, or consist of, glycerol.

As used herein, the term ‘aerosol-generating material’ may, in certain examples, include a ‘flavor’, that is a material that adds a flavor to a generated aerosol. As used herein, the term ‘flavor’ refers to materials which, where local regulations permit, may be used to create a desired taste or aroma in a product for adult consumers.

As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

As used herein, the term ‘tobacco material’ refers to any material comprising tobacco or derivatives therefore. The term ‘tobacco material’ may include one or more of tobacco, tobacco derivatives, expanded tobacco, reconstituted tobacco or tobacco substitutes. The tobacco material may comprise one or more of ground tobacco, tobacco fibre, cut tobacco, extruded tobacco, tobacco stem, reconstituted tobacco and/or tobacco extract.

The tobacco used to produce tobacco material may be any suitable tobacco, such as single grades or blends, cut rag or whole leaf, including Virginia and/or Burley and/or Oriental. It may also be tobacco particle ‘fines’ or dust, expanded tobacco, stems, expanded stems, and other processed stem materials, such as cut rolled stems. The tobacco material may be a ground tobacco or a reconstituted tobacco material. The reconstituted tobacco material may comprise tobacco fibres, and may be formed by casting, a Fourdrinier-based paper making-type approach with back addition of tobacco extract, or by extrusion.

The aerosol-generating material comprising any of, or any combination of, the features and characteristics described above may be provided as a consumable article. A consumable is an article comprising or consisting of aerosol-generating material, part or all of which is intended to be consumed during use by a user. The consumable article may be described as an aerosol forming consumable comprising an aerosol-generating material from which an aerosol may be generated. In some examples, the aerosol forming consumable may include other materials and components in addition to the aerosol-generating material. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor. For example, the aerosol forming consumable may comprise a substrate on which the aerosol-generating material is supported. For example, the aerosol forming consumable may comprise a handling feature that permits a user to handle the aerosol forming consumable without touching the aerosol-generating material of the aerosol forming consumable.

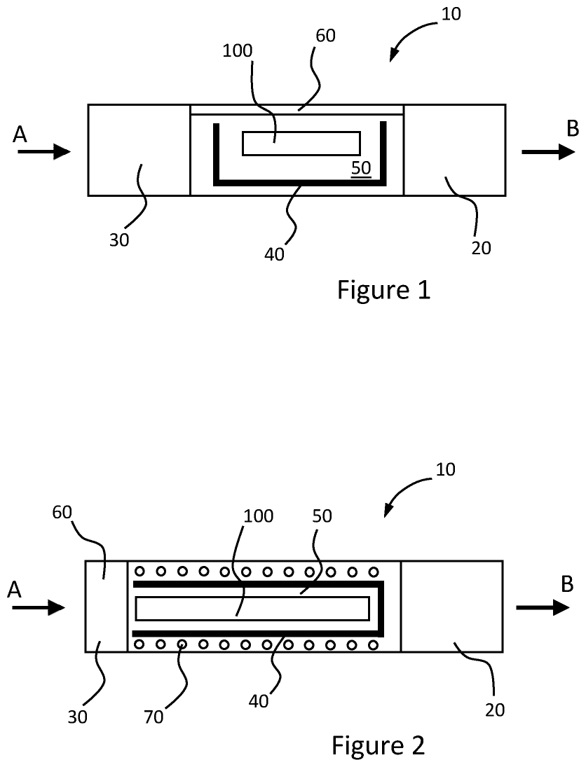

FIG. 1 shows, schematically, an example aerosol generation device 10 for generating an aerosol from an aerosol forming consumable 100. The aerosol forming consumable 100 may be an example of the aerosol forming consumable comprising an aerosol-generating material as described above. The aerosol forming consumable 100 may be receivable in the device 10.

The aerosol generation device 10 may include a housing to support and retain the various components of the device 10. In certain examples, the aerosol generation device 10 may include a mouthpiece 20 through which a user of the device 10 may inhale an aerosol generated by the device 10. In certain examples, the aerosol generation device 10 may include an air inlet 30 through which air is drawn when the user inhales an aerosol generated by the device 10. In the example shown in FIG. 1, when the user inhales, air may be drawn in in the direction of arrow A and the user may inhale an aerosol in the direction of arrow B. In other examples, the aerosol generation device 10 may not include a mouthpiece. For example, a user of the device 10 may inhale an aerosol generated by the device 10 from the aerosol forming consumable 100 itself.

The aerosol generation device 10 may include a heating chamber 50. The heating chamber 50 may be configured to, in use, receive an aerosol forming consumable 100, such as the examples described above. The heating chamber 50 may include an opening to receive the aerosol forming consumable 100. The aerosol forming consumable 100 may be shaped to fit within the heating chamber 50. In certain examples, the aerosol forming consumable 100 may be a rod, or a stick, or a pod that corresponds to the internal shape of the heating chamber 50. The heating chamber 50 may be configured to allow air to pass from the air inlet 30 through the heating chamber 50 and out to the mouthpiece 20 when the user inhales on the mouthpiece 20. The air through the heating chamber 50, when the user inhales, may collect any generated aerosol from the aerosol forming consumable 100 before entering the user's mouth.

The aerosol generation device for 10 may comprise one heater element 40 or a plurality of heater elements 40. In certain examples, the heater element 40 may comprise a plurality of heater element portions. The heater element portions may be formed integrally with one another. In certain examples, where the aerosol generation device for 10 comprises one heater element 40, the heating chamber 50 may be defined, at least in part, by the heater element 40. In certain examples, where the aerosol generation device for 10 comprises the plurality of heater elements, the heating chamber 50 may be defined, at least in part, by the plurality of the heater elements 40. In other examples, where the aerosol generation device for 10 comprises the plurality of heater elements, a plurality of the heating chambers 50 may be provided and defined, at least in part, by the plurality of the heater elements 40.

The heater element(s) 40 may be configured, when the device 10 is in use, to heat the aerosol forming consumable 100. By applying heat to the aerosol forming consumable 100, the aerosol-generating material contained therein may be heated thereby generating an aerosol from the aerosol-generating material. Activating the heater element 40 may be triggered by the user inhaling air through the device 10 or by another means, for example by a switch.

In certain examples, the heating chamber 50 may include a lid 60. The lid 60 may be a closable lid. The lid 60, when closed, may enclose the aerosol forming consumable 100 in the device 10. The lid 60, when closed, may enclose the heating chamber 50 to form an enclosed through which air is drawn from the air inlet 30 to the mouthpiece 20 by a user. The lid 60, when closed, may be configured to allow the aerosol generated from the aerosol forming consumable 100 to escape and be drawn through the mouthpiece 20.

The device 10 may include other componentry that is not shown in FIG. 1. The aerosol generation device 10 may include a system for causing heating of the heater element 40 In certain examples, the device 10 may have a power unit, which holds a source of power which may be, for example, a battery, for providing electrical energy to the device 10. The device 10 may have electrical circuitry connected to the power source for conducting electrical energy to other components within the device 10. In certain examples, the circuitry may connect the power source to the system for causing heating of the heater element 40.

The heater element 40 may be configured to heat but not burn the aerosol-generating material of the aerosol forming consumable 100. In certain examples, the heater element 40 may heat the aerosol forming consumable 100 by conducting heat to the aerosol forming consumable 100. In certain examples, the heater element 40 may heat the aerosol forming consumable 100 by radiating heat to the aerosol forming consumable 100. In certain examples, the heater element 40 may heat the aerosol forming consumable 100 by convection of heat to the aerosol forming consumable 100.

In certain examples, the heater element 40 may be comprise a homogeneous, or substantially homogeneous, material. In certain examples, the heater element 40 may comprise a mixture of materials. In certain examples, the heater element may comprise one or more materials selected from the group consisting of: an electrically-conductive material, a magnetic material, and a magnetic electrically-conductive material.

In certain examples, the heater element 40 may be made from a metallic material. For example, the heater element may comprise a metal or a metal alloy.

In certain examples, the heater element may comprise one or more materials selected from the group consisting of: aluminium, gold, iron, nickel, cobalt, conductive carbon, graphite, plain-carbon steel, stainless steel, ferritic stainless steel, steel, molybdenum, silicon carbide, copper, and bronze.

In certain examples, the heater element 40 may comprise a ceramic. In some examples, the heater element 40 may be made from a mixture of metallic and non-metallic materials. For example, the heater element 40 may be made from a metal material imbedded in a ceramic material. The ceramic material may be any suitable ceramic material, for example, but not limited to, at least one of the following: alumina, zirconia, yttria, calcium carbonate, and calcium sulphate.

In use, the system for causing heating of the heater element 40 may cause the heater element 40 to heat up, i.e. increase in temperature. Heating the heater element 40 may be performed by any suitable heating arrangement.

In certain examples, the system for causing heating of the heater element 40 may comprise heating the heater element 40 by conduction. For example, a heat source may be placed in contact with the heater element 40 and activated when the device 10 is in use.

In certain examples, the system for causing heating of the heater element 40 may comprise an induction heating system to heat the heater element 40.

Induction heating is a process of heating an electrically-conductive object by electromagnetic induction. The process involves penetrating the electrically-conductive object with a varying magnetic field cause heating. The process is described by Faraday's law of induction and Ohm's law. Where the electrically conductive object is then used to heat another element then the electrically conductive object may be called a ‘susceptor’. A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein. The susceptor material may be formed of any suitable susceptor material, such as those materials identified hereinabove, for example at least one of, or any combination of, the following: iron, iron alloys such as stainless steel, mild steel, molybdenum, silicon carbide, aluminium, gold and copper. In certain examples, as used herein, the heater element 40 may be a ‘susceptor’ in that it is heated by induction heating so that it may, in turn, may heat the aerosol forming consumable 100. The heating of the aerosol forming consumable 100 may primarily be by conducting or radiating heat to the aerosol forming consumable 100 from the heater element 40, for example.

Arranging the heater element 40 as a susceptor may provide effective heating of the aerosol forming consumable 100, which may be substantially non-conductive. Furthermore, arranging the heater element 40 as a susceptor may allow the heat pattern of the heat directed to the aerosol forming consumable 100 to be controlled.

The induction heating system may comprise an electromagnet and a device for passing a varying electric current, such as an alternating electric current, through the electromagnet. The varying electric current in the electromagnet produces a varying magnetic field. The varying magnetic field penetrates the electrically-conductive object suitably positioned with respect to the electromagnet, generating eddy currents inside the object. The object has electrical resistance to the eddy currents, and hence the flow of the eddy currents against this resistance causes the object to be heated by Joule heating, which may also be known as ohmic, or resistive heating. It has been found that, when the electrically-conductive object is in the form of a closed electrical circuit, magnetic coupling between the object and the electromagnet in use is enhanced, which results in greater or improved Joule heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule and magnetic hysteresis heating. In cases where the heater element 40 comprises ferromagnetic material such as iron, nickel or cobalt, heat may also be generated by magnetic hysteresis losses in the heater element 40, i.e. by the varying orientation of magnetic dipoles in the magnetic material as a result of their alignment with the varying magnetic field.

In each of the above processes, as heat is generated inside the object itself, rather than by an external heat source by heat conduction, a rapid temperature rise in the object and more uniform heat distribution can be achieved, particularly through selection of suitable object material and geometry, and suitable varying magnetic field magnitude and orientation relative to the object. Thus, induction heating, as compared to heating by conduction for example, may allow for rapid heating of the heater element 40 since heat is generated inside the heater element 40 (susceptor). Furthermore, as induction heating and magnetic hysteresis heating do not require a physical connection to be provided between the source of the varying magnetic field and the object, design freedom and control over the heating profile may be greater, and cost may be lower. Hence, there need not be any physical contact between the inductive heating system and the heater element 40, allowing for enhanced freedom in construction, application, and reliability of the aerosol generation device 10.

An example of the aerosol generation device 10 in which the system for causing heating of the heater element 40 comprises an induction heating system 70 to heat the heater element 40 is shown in FIG. 2. FIG. 2 shows just one example of a system for causing heating of the heater element 40. For convenience and clarity, the system for causing heating of the heater element 40 is not shown in any other figures. As with the device 10 illustrated in FIG. 1, the aerosol generation device 10 includes a mouthpiece 20 and an air inlet 30. In the case of the device 10 of FIG. 2, the air inlet 30 may also act as a lid 60 covering user access to the heating chamber 50 and allowing a user to insert an aerosol forming consumable 100 into the aerosol generation device 10. In certain examples, the air inlet/lid may not be present on the device 10 and air may be drawn in through an open end of the device 10. In the example device 10 shown in FIG. 2, the heating chamber 50 is defined by an elongated heater element 40 that is open at one end to allow the aerosol forming consumable 100 to be inserted into the heating chamber 50. In FIG. 2, it can be seen that the induction heating system 70 comprises an induction coil that is wrapped around the heater element 40. The heater element 40 and induction coil are shown as a cross section through the axis of the coil. The elongated heater element 40 may, for example, be an elongate tubular shape, such as one of the example heater elements 40 described below. When the induction coil is energized with an alternating current, the resulting varying magnetic field heats the heater element 40 and, thereby, heats the aerosol forming consumable inserted into the heating chamber 50.

In certain examples, the system for causing heating of the heater element 40 may comprise the heater element 40 arranged as an electrically resistive heater. Thus, the system for causing heating of the heater element 40 may comprise circuitry for connecting the heater element 40 a power source. In use, an electrical current from the power source may be passed through the heater element 40 to cause Joule heating of the heater element 40. The heater element 40 may be any suitable material that forms an electrical conductor, for example a metallic material. In an example, the system for causing heating of the heater element 40 may comprise a controller that may control the electrical current passing through the heater element and therefore the amount of heat generated by the heater element 40.

In certain examples, the system for causing heating of the heater element 40 may comprise a thermal radiant heating system. In an example, the thermal radiant heating system may comprise a heat lamp that radiates thermal energy to the heater element 40. For example, the thermal radiant heating system may comprise an infrared light source directed at the heater element 40. For example, the thermal radiant heating system may comprise radiant heat sources such as LEDs or LASERs.

In certain examples, the system for causing heating of the heater element 40 may comprise a chemical heating system. For example, system for causing heating of the heater element 40 means may comprise a chemical heat source which undergoes an exothermic reaction to product heat in use.

Where the aerosol generation device 10 comprises the plurality of heater elements 40, each heater element 40 may be, in certain examples, provided with a respective system for causing heating of the heater element. In other examples, a system for causing heating of the heater element may heat more than one heater element 40. For example, where a plurality of heater elements 40 are arranged linearly, as described below, a single system, such as an induction heating coil surrounding all the heater elements 40 may be provided.

The heater element 40 may be movable to reduce a volume of the heating chamber 50 from a first volume to a second volume.

By reducing the volume of the heating chamber 50 from the first volume to the second volume the heater element 40 maybe positioned closer to the aerosol forming consumable 100. In certain examples, heater element of 40 may more closely mate with a surface of the aerosol forming consumable 100. In certain examples, heater element of 40 may apply a force to the surface of the aerosol forming consumable 100. For example, the heater element 40 may compress the aerosol forming consumable 100. By reducing the distance between the heater element 40 and the surface of the aerosol forming consumable 100, the transfer of thermal energy between the heater element 40 and the aerosol forming consumable 100 can be improved. Improving the transfer of thermal energy between the heater element 40 and the aerosol forming consumable 100 may increase the efficiency of aerosol generation from the aerosol forming consumable 100. Improving the transfer of thermal energy between the heater element 40 and the aerosol forming consumable 100 may also reduce the energy consumable by the device 10 thereby increasing its energy efficiency. Where the reduction in volume is such that contact is made between the heater element 40 and the aerosol forming consumable 100, the improved conduction of thermal energy between the heater element 40 and the aerosol forming consumable 100 may be particularly beneficial to improving the efficiency of the aerosol generation device 10.

In certain examples, when the aerosol generation device 10 is in use, the heater element 40 may be constrictable to reduce the volume of the heating chamber from the first volume to the second volume. In other words, when the heater element 40 constricts, the heating chamber 50 shrinks or contracts. In this way, the heating chamber 50 draws in on the aerosol forming consumable 100 so that the distance between the heater element 40 and the aerosol forming consumable 100 is reduced and thermal transfer between the heater element 40 and the aerosol forming consumable 100 is improved. In certain examples, the constriction of the heater element 40 may shrink the heating chamber 50 to the extent that the heater element 40 presses in on, and makes contact with, the aerosol forming consumable 100 so that the thermal conduction between the heater element 40 and the aerosol forming consumable 100 is improved.

In certain examples, the heater element 40 may be configured so that it is constrictable by collapsing the heater element 40. In certain examples, the heater element 40 may encircle the aerosol forming consumable 100 when it is inserted into the heating chamber 50. The heater element 40 may comprise a discontinuity. The discontinuity may allow portions of the heater element 40 to move relative to each other so that the heating element 40 collapses and the heating chamber 50 reduces in volume. Some examples of this arrangement are described below.

In certain examples, the heater element 40 may comprise a first portion and a second portion. The first portion may be integrally formed with the second portion. In certain examples, the heater element 40 may comprise a plurality of portions. Each portion of the plurality of portions may be integrally formed with at least one other portion of the plurality of portions.

In certain examples, when the aerosol generation device 10 is in use, the first portion of the heater element 40 may be moveable relative to the second portion of the heater element 40 to reduce the volume of the heating chamber 50 from the first volume to the second volume. In other words, the heating chamber 50 may be arranged so that, when the first portion of the heater element 40 moves relative to the second portion, the heating chamber 50 shrinks. In this way, the first portion and/or the second portion of the heater element 40 may draw in on the aerosol forming consumable 100 so that the distance between the first portion and/or the second portion of the heater element 40 and the aerosol forming consumable 100 is/are reduced and thermal transfer between the heater element 40 and the aerosol forming consumable 100 is improved. In certain examples, the first portion and/or the second portion of the heater element 40 may shrink the heating chamber 50 to the extent that the heater element 40 presses in on, and makes contact with, the aerosol forming consumable 100 so that the thermal conduction between the heater element 40 and the aerosol forming consumable 100 is improved.

In certain examples, when the aerosol generation device 10 is in use and where the heater element 40 comprises a plurality of portions, one portion of the heater element 40 may be moveable relative to another portion of the heater element 40 to reduce the volume of the heating chamber 50 from the first volume to the second volume. In other words, the heating chamber 50 may be arranged so that, when the portion of the heater element 40 moves relative to the other portion, the heating chamber 50 shrinks. In this way, the portion and/or the plurality of portions of the heater element 40 may draw in on the aerosol forming consumable 100 so that the distance between the portion and/or the plurality of portions of the heater element 40 and the aerosol forming consumable 100 is/are reduced and thermal transfer between the heater element 40 and the aerosol forming consumable 100 is improved. In certain examples, the portion and/or the plurality of portions of the heater element 40 may shrink the heating chamber 50 to the extent that the heater element 40 presses in on, and makes contact with, the aerosol forming consumable 100 so that the thermal conduction between the heater element 40 and the aerosol forming consumable 100 is improved.

In certain examples, where the aerosol generation device 10 comprises the constrictable heater element 40, the heater element 40 may comprise a first portion and a second portion. When the aerosol generation device 10 is in use, the constriction of the heater element 40 may be by movement of the first portion relative to the second portion of the heater element 40 to reduce the volume of the heating chamber 50 from a first volume to a second volume. In other words, the shrinking or contracting of the heating chamber 50, which is caused by the constriction of the heater element 40, results from the movement of the first portion of the heater element 40 relative to the second portion of the heater element 40.

An aerosol forming consumable, for example any one of the aerosol forming consumables described above, may be heated according to the following methods.

In certain examples, the methods comprise receiving an aerosol forming consumable in a heating chamber of an aerosol generation device. The heating chamber may be least partially defined by a heater element that is constrictable.

In certain examples, the method also comprises constricting the heater element to reduce the volume of the heater chamber from a first volume to a second volume.

In certain examples, the method also comprises moving a first portion of the heater element relative to a second portion of the heater element, the second portion integrally formed with the first portion, to reduce a volume of the heating chamber from a first volume to a second volume.

In certain examples, the method may comprise maintaining the temperature of the heater element at a constant temperature when the heating chamber has the second volume. In certain examples, the method may comprise varying the temperature of the heater element when the heater element has the second volume.

A temperature and/or heat transfer sensor may be provided on the aerosol generation device in order to monitor the temperature of the aerosol forming consumable and/or heat transferred to the aerosol forming consumable 100. For example, a temperature sensor monitor may be installed inside the heating chamber 50.

In certain examples, the heating chamber 50 may be substantially tubular. As discussed briefly above, the heating chamber 50 may be defined, at least in part, by the heater element 40. For example, the heater element 40 may form one wall, or portion of a wall, of the heating chamber 50 whilst the remaining walls, or portion of the wall, of the heating chamber are not formed by the heater element 40. In certain examples, the heating chamber 50 may be substantially tubular and be defined by a tubular wall in which the tubular wall is partially formed by the heater element 40.

In certain examples, the heating chamber 50 may be defined substantially by the heater element 40. In other words, in certain examples, the heating chamber 50 may be defined mostly by the heater element 40. In certain examples, the heating chamber 50 may be substantially tubular and may be defined by a tubular wall in which the tubular wall is substantially formed by the heater element 40. For example, the heater element 40 may encircle the aerosol forming consumable 100 when it is inserted into the heating chamber 100. In such instances, some portions of the heating chamber 50 may be defined by other components of the aerosol generation device 10, which may be present for functional or constructional reasons.

The heating chamber 50 may be substantially hollow. In certain examples, the heating chamber 50 may be substantially tubular and may be substantially hollow. In one such example, the tubular heating chamber 50 may be open at one end, to allow the insertion of the aerosol forming consumable 100. In certain examples, the tubular heating chamber 50 may be closed, or partially closed, at the other end to form a support for the aerosol forming consumable 100 and provide tactile feedback to indicate to a user that aerosol forming consumable 100 is fully inserted into the heating chamber 50.

The tubular heating chamber 50 may have a cross section that is defined by a cutting plane that is perpendicular to a longitudinal direction of the tubular heating chamber 50, i.e. along the length of the tubular heating chamber 50. In certain examples, the tubular heating chamber 50 may have a substantially circular cross section. The tubular heating chamber 50 may therefore be substantially cylindrical in the longitudinal direction, i.e. along the length of the tubular shape. In other tubular heating chamber 50 examples, the cross section may be square, rectangular, or elliptical, for example, or any suitable shape to form any suitably shaped tubular heating chamber 50.

In an example, where the heating chamber 50 is substantially tubular, the aerosol forming consumable 100 may have a shape that corresponds to the internal shape of the heating chamber 50. For example, where the tubular heating chamber 50 is substantially cylindrical in its longitudinal direction, the aerosol forming consumable 100 may have a substantially circular cross section so that the aerosol forming consumable 100 is substantially cylindrical in a longitudinal direction, i.e. along the length of the consumable 100. In certain examples, the aerosol forming consumable 100 may be a rod, or a stick, or a pod that corresponds to the internal shape of the heating chamber 50.

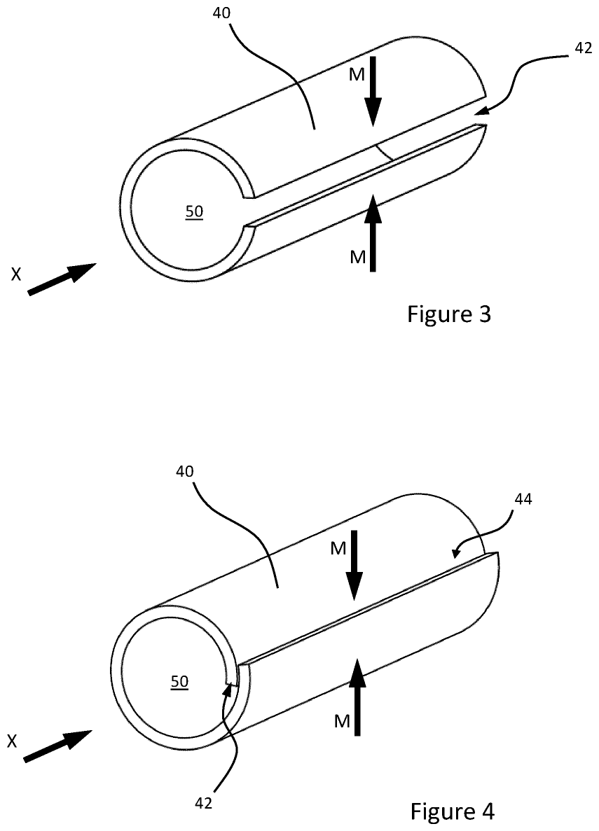

Certain heater element 40 examples will now be described with respect to FIGS. 3 to 7.

FIG. 3 illustrates an example heater element 40 comprising an elongate hollow tube. The elongate hollow tube may be defined by a tubular wall. The elongate hollow tube may have a longitudinal direction, that is, a direction along the length of the elongate hollow tube. The elongate hollow tube may have a cross section that is defined by a cutting plane that is perpendicular to the longitudinal direction of the elongate hollow tube. The elongate hollow tube has a cross section, which, in the example of FIG. 3, is substantially circular. The elongate hollow tube may therefore be substantially cylindrical in the longitudinal direction. In other elongate hollow tube examples, the cross section may be square, rectangular, or elliptical, for example, or any suitable shape to form any suitably shaped elongate hollow tube.

The heating chamber 50 is defined by the internal volume of the elongate hollow tube. In the example shown in FIG. 3, the heating chamber 50 is substantially cylindrical in shape and, therefore, may receive therein a suitably sized and substantially cylindrical aerosol forming consumable 100. The aerosol forming consumable 100 may be inserted into heating chamber 50 in the direction of arrow X.

In the example shown in FIG. 3, the heater element 40, except for the open end that allows the consumable 100 to be inserted into the heating chamber 50, for the most part defines the heating chamber 50. The heater element 40 therefore substantially encompasses the aerosol forming consumable 100. The heating chamber 50 may also be partially defined by a surface opposite the opening, which acts to locate and form a resting position for the consumable 100 when it is inserted into the heating chamber 50.

In the example shown in FIG. 3, the elongate hollow tube comprises a split 42 in the tubular wall of the elongate hollow tube. The split 42 allows the heater element 40 to be constrictable to reduce the volume of the heating chamber from a first volume to a second volume. The heater element 42 is constrictable by collapsing in the direction of arrows M. In this way, the heater element 40 may have first and second portions and one, or both, of the portions may move in the indicated directions to constrict the heater element 40.

The elongate hollow tube may have tubular wall ends defined by the split 42 in the tubular wall defining the elongate hollow tube. In the example shown in FIG. 3, where the elongate hollow tube is cylindrical, the elongate hollow tube may have a circumferential direction and a radial direction. Accordingly, the tubular wall ends may be described as moving in the circumferential direction of the elongate hollow tube, i.e. direction of arrows M, in order to effect the constriction of the heater element 40. In the example shown in FIG. 3, the split 42 results in the heater element 40 comprising the elongate hollow tube having a C-shaped cross section.

When the device 10 is in use and the heater element 40 is activated to constrict, the constriction may result in the reduction of at least one, or all of, the internal dimensions of the elongate hollow tube. For example, when the heater element 40 is activated to constrict, the constriction may result in the reduction of the width of the elongate hollow tube. For example, where the elongate hollow tube is cylindrical as in FIG. 3, the elongate hollow tube may have a diameter and, when the device 10 is in use and the heater element 40 of FIG. 3 is activated to constrict, the constriction results in the reduction of the diameter of the elongate hollow tube to reduce the volume of the heating chamber 50 from a first volume to a second volume. Thus, the heater element 40 comprising the elongate hollow tube is brought closer to, or compresses on, a cylindrically shaped aerosol forming consumable 100 inserted into the heating chamber 50 by the user. In this way, the heating chamber 50 provides a clearance around the aerosol forming consumable 100 when it is inserted and provides improves thermal transfer to the aerosol forming consumable 100 when the device 10 is in use and the heater element 40 is constricted.

In FIG. 3, where the elongate hollow tube is cylindrical, the split 42 may be described as being located at a point on the circumference of the circular cross section of the elongate hollow tube and as extending linearly lengthwise along the tube. In other examples, where the cross section is not circular, the split may be described as being located at a point on a perimeter of the cross section of the elongate hollow tube.

In the example shown in FIG. 3, the split 42 extends in the longitudinal direction along the elongate hollow tube; however, in other examples, the split may extend linearly and be set at angle to the longitudinal direction. In another example, the split may be helical in shape, which may allow the constriction of the heater element 40 to be performed by twisting (imparting a measure of torque) the tubular heater element 40. For example, the split may be a shallow helix shape in that the completes less than one revolution along the length of the elongate hollow tube.

FIG. 4 illustrates another example heater element 40 comprising an elongate hollow tube. Again, the elongate hollow tube may be defined by a tubular wall. As with the example in FIG. 3, the elongate hollow tube may have a longitudinal direction and have a cross section that is defined by a cutting plane that is perpendicular to the longitudinal direction of the elongate hollow tube. In FIG. 4, the elongate hollow tube has a cross section that is substantially circular so that the elongate hollow tube is substantially cylindrical in the longitudinal direction and has circumferential and radial directions. Again, the heating chamber 50 is substantially cylindrical in shape and, therefore, may receive therein a suitably sized and substantially cylindrical aerosol forming consumable 100. The aerosol forming consumable 100 may be inserted into heating chamber 50 in the direction of arrow X.

As with the example shown in FIG. 3, the elongate hollow tube of FIG. 4 comprises a split 42 in the tubular wall of the heater element 40. The elongate hollow tube may have tubular wall ends defined by the split 42. The elongate hollow tube of FIG. 4 also comprises an overlap 44 in that the tubular wall ends overlap in the circumferential direction to be adjacent to each other. In the example shown in FIG. 4, the split 42 and overlap of the tubular wall ends may result in the elongate hollow tube having a spiral-shaped cross section. The tubular wall ends of the may be offset from each other to allow relatively frictionless movement of the wall ends with respect to each other. In some examples, a suitable clearance distance may be provided between the tubular wall ends.

The split 42 shown in FIG. 4 allows the heater element 40 to be constrictable to reduce the volume of the heating chamber from a first volume to a second volume. The heater element 40 is constrictable by collapsing in the direction of arrows M. In this way, the heater element 40 may have first and second portions and one, or both, of the portions may move in the indicated directions to increase the overlap of the portions and constrict the heater element 40. The tubular wall ends may be described as moving in the circumferential direction, i.e. direction of arrows M, in order to effect the constriction of the heater element 40. The overlapping tubular wall ends of the cylindrical wall may move past each other to increase the overlap as the heater element 40 is constricted.

When the device 10 is in use and the heater element 40 is activated to constrict, the constriction may result in the reduction of at least one, or all of, the internal dimensions of the elongate hollow tube. For example, where the elongate hollow tube is cylindrical as in FIG. 4, the elongate hollow tube may have a diameter and, when the device 10 is in use and the heater element 40 of FIG. 4 is activated to constrict, the constriction results in the reduction of the diameter of the elongate hollow tube to reduce the volume of the heating chamber 50 from a first volume to a second volume. Thus, the heater element 40 comprising the elongate hollow tube is brought closer to, or compresses on, a cylindrically shaped aerosol forming consumable 100 inserted into the heating chamber 50 by the user. In this way, the heating chamber 50 provides a clearance around the aerosol forming consumable 100 when it is inserted and provides improves thermal transfer to the aerosol forming consumable 100 when the device 10 is in use and the heater element 40 is constricted. The overlapping ends of the cylindrical wall of the heater element 40 may further reduce air gaps between the aerosol forming consumable and the heater element 40 thereby reducing thermal loss and increasing the efficiency of the device.

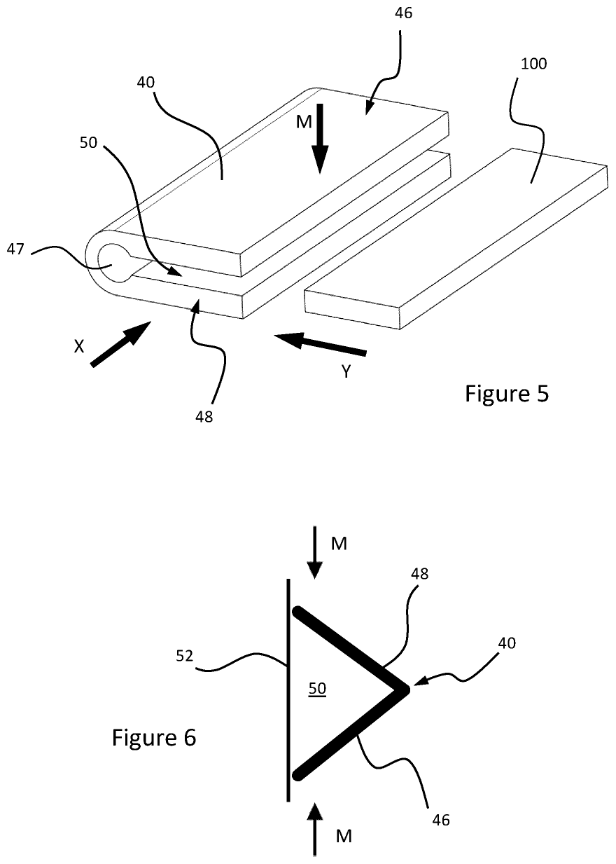

FIG. 5 illustrates an example heater element 40 comprising a first portion 46 integrally formed with a second portion 48. In the example illustrated in FIG. 5 the first portion 46 is offset from the second portion 48. The heating chamber 50 is the space defined between the first portion 46 and the second portion 48. The first portion 46 and the second portion 48 of the heater element 40 form a sleeve that envelops an aerosol forming consumable 100 inserted into the heating chamber 50. An aerosol forming consumable 100 may be inserted into the heating chamber 50 in the direction of either X or Y depending on the desired arrangement of the aerosol generation device 10. In the example illustrated in FIG. 5, the aerosol forming consumable 100 is formed as rectangular strip that can slot into the sleeve shaped heating chamber 50. In other examples, the aerosol forming consumable 100 may be any suitable shape that may correspond with the space defined by the two portions 46, 48 of the heater element 40.

In the example shown in FIG. 5, when the aerosol generation device 10 is in use, the first portion 46 of the heater element 40 may be moveable relative to the second portion 48 of the heater element 40 to reduce the volume of the heating chamber 50 from a first volume to a second volume. The first portion 46 may move in the direction of arrow M as shown in FIG. 5, which results in the heating chamber 50 shrinking.

In this way, the heater element 40 may be said to be constricting in order to reduce the volume of the heating chamber 50. In certain examples, the first portion 46 may move to the extent that the first 46 and/or the second portions 48 of the heater element 40 press in on the aerosol forming consumable 100 so that the thermal conduction between the heater element 40 and the aerosol forming consumable 100 is improved.

The heater element 40 example illustrated in FIG. 5 may include a thinned portion that defines a notch 47 in the region were the first 46 and second 48 portions integrate with each other. The thinned portion may facilitate the movement of the first portion 46 relative to the second portion 48 in a reliable manner. Further, the thinned portion may ensure the movement of the first portion 46 relative to the second portion 48 results in an even pressure being applied to the aerosol forming consumable 100 instead of the regions closest to the flexing point exerting a larger relative pressure.

FIG. 6 illustrates an example heater element 40 comprising a first portion 46 integrally formed with a second portion 48. FIG. 6 shows the heater element 40 end on such that the cross-sectional shape of the heater element 40 is illustrated. In FIG. 6 the heater element 40 extends lengthwise perpendicularly to the illustrated cross section, i.e., perpendicular to the page.

In the example illustrated in FIG. 6, the first portion 46 is set at an angle from the second portion 48. The heating chamber 50 is the space defined between the first portion 46 and the second portion 48. In an example, the heating chamber 50 may also be defined by a third wall 52 that is not part of the heater element 40. Thus, in the example shown in FIG. 6, the heating chamber 50 is a triangular prism shaped space between the two heater element 40 portions 46, 48 and the third wall 52. A complementarily shaped aerosol forming consumable 100 may be inserted into the heating chamber 50 in the lengthwise direction of the heater element 50. The aerosol forming consumable 100 may also have a triangular prism shape.

In the example shown in FIG. 6, when the aerosol generation device 10 is in use, the first portion 46 of the heater element 40 may be moveable relative to the second portion 48 of the heater element 40 to reduce the volume of the heating chamber 50 from a first volume to a second volume. The first portion 46 and/or the second portion 48 may move in the direction of arrows M as shown in FIG. 6, which results in the heating chamber 50 shrinking. In this way, the heater element 40 may be said to constrict to reduce the volume of the heating chamber 50. In certain examples, the first portion 46 and/or the second portion 48 may move to the extent that the first 46 and/or the second portions 48 of the heater element 40 press in on the aerosol forming consumable 100 so that the thermal conduction between the heater element 40 and the aerosol forming consumable 100 is improved.

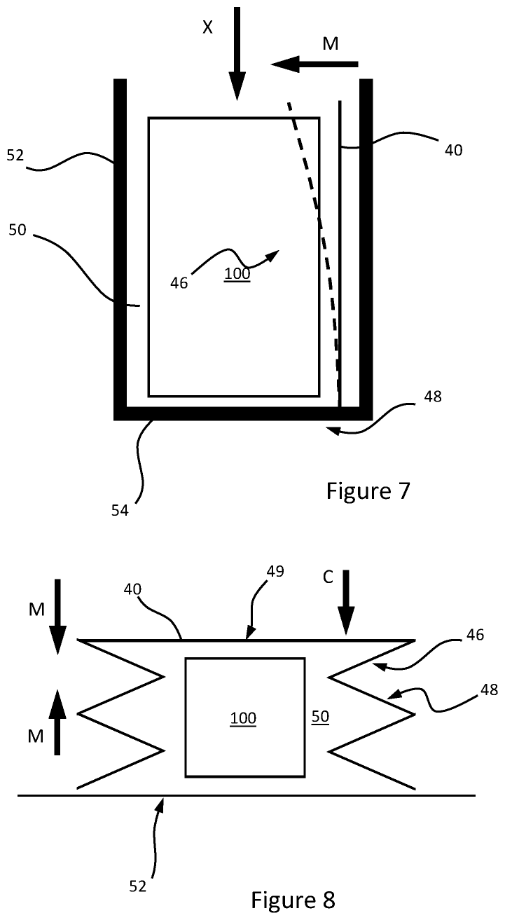

FIG. 7 illustrates an example of a heating chamber 50 that is partially defined by a heater element 40 that forms one wall of the heating chamber 50. The heating chamber 50 is also partially defined by walls 52, 54 that are not part of the heater element 40. The heating chamber 50 is open at one end to allow an aerosol forming consumable 100 to be inserted into the heating chamber 50. The aerosol forming consumable 100 may be inserted into the chamber in the direction of arrow X.

The heater element 40 may comprise a first portion 46 integrally formed with a second portion 48. In the example shown in FIG. 7, when the aerosol generation device 10 is in use, the first portion 46 of the heater element 40 may be moveable relative to the second portion 48 of the heater element 40 to reduce the volume of the heating chamber 50 from a first volume to a second volume. The first portion 46 and/or the second portion 48 may move in the direction of arrow M as shown in FIG. 7, which results in the heating chamber 50 shrinking. The movement of the heater element 40 may be described as a deflection from a resting position to an in-use position in which the distance between the heater element 40 and the aerosol forming consumable 100 is reduced. The first portion 46 may move a relatively larger distance in the direction of arrow M in comparison with the second portion 48. In certain examples, the first portion 46 and/or the second portion 48 may move to the extent that the first 46 and/or the second portions 48 of the heater element 40 press in on the aerosol forming consumable 100 so that the thermal conduction between the heater element 40 and the aerosol forming consumable 100 is improved.

In one example of the heater element 40 shown in FIG. 7, the heater element 40 may be a bimetallic strip. When the system for causing heating of the heater element 40 is activated the bimetallic strip deflects, due to the differing expansion rates of its constituent metals, and the heating element 40 draws closer to the aerosol forming consumable 100.

In one example of the heater element 40 shown in FIG. 7, the heater element 40 may be a piezoelectric actuator formed in a strip shape. When the piezoelectric actuator is energized the strip deflects and the heating element 40 draws closer to the aerosol forming consumable 100, the piezoelectric actuator may apply a force to the aerosol forming consumable 100 and thereby improve thermal conduction between the heater element 40 and the aerosol forming consumable.

FIG. 8 illustrates an example heater element 40 comprising a plurality of portions in which each portion is integrally formed with at least one other portion of the plurality of portions. The heater element 40 illustrated in FIG. 8 may be described as a bellows, for example. FIG. 8 shows the heater element 40 end on such that the cross-sectional shape of the heater element 40 is illustrated. In FIG. 8 the heater element 40 extends lengthwise perpendicularly to the illustrated cross section, i.e., perpendicular to the page.

The heating chamber 50 is the internal space defined by the bellows. In an example, the heating chamber 50 may also be defined by a third wall 52 that is not part of the heater element 40. A complementarily shaped aerosol forming consumable 100 may be inserted into the heating chamber 50 in the lengthwise direction of the heater element 50. For example, the aerosol forming consumable 100 may formed as rectangular strip that can be placed inside the bellows by a user of the aerosol generation device 10.

In the example shown in FIG. 8, when the aerosol generation device 10 is in use, one portion 46 of the heater element 40 may be moveable relative to another portion 48 of the heater element 40 to reduce the volume of the heating chamber 50 from a first volume to a second volume. The portion 46 and/or the other portion 48 may move in the direction of arrows M as shown in FIG. 8, which results in the heating chamber 50 shrinking. These movable portions of the bellows may be described as folds of the bellows. For example, with the heater element 40 shown in FIG. 8, all the portions of the plurality of portions may be movable relative to each other. For example, all the folds that form flexible part of the bellows may be movable to collapse the bellows on to itself. In this way, a top portion 49 of the bellows can be drawn in on the aerosol forming consumable 100. In certain examples, the bellows may collapse to the extent that top portion 49 of the heater element 40 bellows presses in on the aerosol forming consumable 100 so that the thermal conduction between the heater element 40 and the aerosol forming consumable 100 is improved.

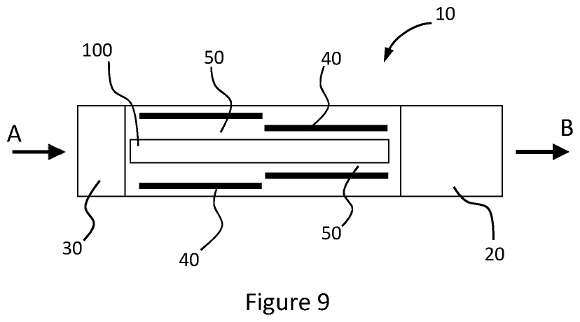

As discussed above, in certain examples, the heater element 40 may be one of a plurality of heater elements 40. FIG. 9 illustrates an example aerosol generation device 10 in which the two heater elements 40 are provided. In other examples, any suitable number of heater elements 40 may be provided.

In the example of FIG. 9, the heater elements 40 are arranged in series in the aerosol generation device 10 such that an elongate aerosol forming consumable 100 may be received within the heating chamber 50 defined, at least in part, by the respective heater elements 40. It should be understood that a plurality of heater elements, such as the examples described herein, may be arranged in other ways in the aerosol generation device. For example, the plurality of heater elements be arranged in a radial array and configured to receive a corresponding plurality of aerosol forming consumables.

In the example shown in FIG. 9, the heater elements 40 may be moved towards or away from the aerosol forming consumable 100 independently of each other. FIG. 9 shows, schematically, that one of the heater elements 40 is closer to the aerosol forming consumable 100 than the other heater element 40. In this way, different portions of the aerosol forming consumable 100 can be temperature controlled independently. For example, one portion of the aerosol forming consumable 100 may be heated before another portion of the aerosol forming consumable 100 so that the first portion is consumed by a user before the second portion.

In another example, the aerosol forming consumable 100 may be kept at a predetermined temperature profile relative to its length as it is heated and consumed by a user of the device 10. For example, one portion of the aerosol forming consumable 100 may be kept at a higher temperature than another portion of the aerosol forming consumable 100. This may, for example, allow a flavor aerosol to be released from one portion of the aerosol forming consumable 100 whilst a nicotine carrying aerosol is released from another portion of the aerosol forming consumable 100.

The aerosol generation device 10 may comprise an actuation system to cause the heater element 40 move and reduce the volume of the heating chamber 50 from a first volume to a second volume.

In certain examples, the actuation system may comprise a biasing mechanism that exerts a force on the heater element 40. For example, the actuation system may comprise a spring. The spring may exert a biasing force or torque on the heater element 40 for example. The biasing mechanism could be activated manually by a user, for example. In another example, the biasing mechanism may be activated, on instructions from a controller or a user-initiated switch, by an electrical component such as, for example, a solenoid.

In certain examples, the actuation system may comprise the heating system for causing heating of the heater element 40. For example, where the heating system for causing heating of the heater element 40 is an induction heating system, the heating of the heater element 40 may be utilized to cause the necessary movement of the heater element 40. For example, where the heater element 40 is a bimetallic strip, the inductive heating of the bimetallic strip will cause it to deflect. Equally, the use of an electrically resistive heating system may be used to the same effect on the heater element 40. The actuation system may itself be activated on instructions from a controller or a user-initiated switch.

In certain examples, the actuation system may comprise a separate electrical system for actuating movement of the heater element 40. For example, the heater element 40 may be configured to be conductive and be configured to change shape on being energized by the electrical system for actuating movement of the heater element 40. For example, passing electrical charge through the piezoelectrical actuator described above may cause it to deflect and move closer to the aerosol forming consumable 100. Again, actuation system may itself be activated on instructions from a controller or a user-initiated switch.

As described above, the actuation system may itself be activated on instructions from a controller, or by a user-initiated switch, or manually by the user. The actuation system may be activated as soon as a user has inserted the aerosol forming consumable 100 into the heating chamber 50. For example, the actuation system may be triggered by the user closing the lid 60 that covers the heating chamber 50. The lid 60 may exert the biasing force or press an electrical switch in the heating chamber 60 when it is closed, for example. In an example, the actuation system may be triggered by a user inhaling on the mouthpiece 20 by the aerosol generation device 10 detecting the inhalation action of the user. In an example, the actuation system may be activated by a user engaging a functional switch on the aerosol generation device 10.

The actuation system may be released to cause the heater element 40 move and return the volume of the heating chamber 50 from a second volume to a first volume. In this way, the aerosol forming consumable 100 may be released from the heating chamber 50.

In certain examples, the actuation system may synchronize with the user's inhalation cycle. For example, after each inhalation of the user has been determined to have ended, the actuation mechanism may be released so that the heating chamber 50 returns to the first volume. This may reduce the heat delivered to aerosol forming consumable 100 when the user is not inhaling on the device 10 and may, therefore, prolong the life of the aerosol forming consumable 100.

In certain examples, the actuation system may be activated as soon as an aerosol forming consumable 100 and not released until the user decides, or is prompted to, replace the aerosol forming consumable 100.

The aerosol generation device may be provided to a user as an aerosol generation system that contains at least one aerosol forming consumable for use with the aerosol generation device. The aerosol generation system may contain a plurality of like aerosol forming consumables for use with the aerosol generation device. The at least one aerosol forming consumable is shaped and sized to be receivable within the aerosol generation device heater element since the aerosol generation device heater element defines, at least in part, a heating chamber for receiving the at least one aerosol forming consumable

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol generation device for generating an aerosol from an aerosol forming consumable, the aerosol generation device comprising:
at least one heater element, the heater element defining, at least partially, a heater chamber for receiving the aerosol forming consumable therein;
a system for causing heating of the heater element; and
wherein the heater element is constrictable, in use, to reduce a volume of the heater chamber from a first volume to a second volume.

2. The aerosol generation device according to claim 1 wherein the heater element encircles the aerosol forming consumable when the aerosol forming consumable is inserted into the heating chamber.

3. The aerosol generation device according to claim 1 wherein the heater element comprises an elongate hollow tube.

4. The aerosol generation device according to claim 3 wherein the heater element is configured to constrict to reduce an internal dimension of the elongate hollow tube.

5. The aerosol generation device according to claim 3 wherein the elongate hollow tube is defined by a tubular wall and wherein the elongate hollow tube comprises a split in the tubular wall of the elongate hollow tube.

6. The aerosol generation device according to claim 5 wherein the split extends longitudinally along the elongate hollow tube.

7. The aerosol generation device according to claim 6 wherein the elongate hollow tube has a C-shaped cross section.

8. The aerosol generation device according to claim 3 wherein the elongate hollow tube has a substantially circular cross section.

9. The aerosol generation device according to claim 6, wherein the elongate hollow tube has a substantially circular cross-section, wherein the elongate hollow tube has tubular wall ends defined by the split and wherein the tubular wall ends move in a circumferential direction of the elongate hollow tube when the heater element constricts in use.

10. The aerosol generation device according to claim 9 wherein the tubular wall ends overlap in the circumferential direction of the elongate hollow tube.

11. The aerosol generation device according to claim 8 wherein the heater element is configured to constrict to reduce a diameter of the elongate hollow tube.

12. An aerosol generation device for generating an aerosol from an aerosol forming consumable, the aerosol generation device comprising:
at least one heater element, the heater element defining, at least partially, a heater chamber for receiving the aerosol forming consumable therein;
a system for causing heating of the heater element; and
wherein the heater element comprises a first portion and a second portion integrally formed with the first portion and wherein the first portion of the heater element is, in use, moveable relative to the second portion of the heater element to reduce a volume of the heater chamber from a first volume to a second volume.

13. The aerosol generation device according to claim 12 wherein the first portion and the second portion form a sleeve, and wherein the sleeve envelops the aerosol forming consumable when it is received in the heating chamber.

14. The aerosol generation device according to claim 12 wherein the heating chamber is a triangular prism shaped space defined, at least partially, by the first portion and the second portion.

15. The aerosol generation device according to claim 12 wherein the heater element comprises a bimetallic strip.

16. The aerosol generation device according to claim 12 wherein the heater element comprises a piezoelectric actuator.

17. The aerosol generation device according to claim 12 wherein the heater element comprises a bellows.

18. The aerosol generation device according to claim 1 wherein the heater element comprises a homogeneous, or substantially homogeneous, material.

19. The aerosol generation device according to claim 1 wherein the at least one heater element comprises a plurality of heater elements and wherein each of the heater elements may be moved, in use, towards or away from the aerosol forming consumable independently of each other.

20. The aerosol generation device according to claim 1 wherein the system for causing heating of the heater element is an inductive heating system or a resistive heating system.

21. An aerosol generation system comprising the aerosol generation device according to claim 1 at least one aerosol forming consumable, wherein the at least one aerosol forming consumable is shaped and sized to be receivable within the heating chamber.

22. A method of heating an aerosol forming consumable, the method comprising:
receiving an aerosol forming consumable in a heating chamber of an aerosol generation device, the heating chamber at least partially defined by a heater element that is constrictable;
constricting the heater element to reduce a volume of the heater chamber from a first volume to a second volume.

23. A method of heating an aerosol forming consumable, the method comprising:
receiving an aerosol forming consumable in a heating chamber of an aerosol generation device, the heating chamber at least partially defined by a heater element that is constrictable;
moving a first portion of the heater element relative to a second portion of the heater element, the second portion integrally formed with the first portion, to reduce a volume of the heating chamber from a first volume to a second volume.
